(19) United States
(12) Patent Application Publication
(10) Pub. No.: US 2021/0050791 A1
(43) Pub. Date: Feb. 18, 2021

(54) POWER SUPPLY DEVICE AND NON-TRANSITORY COMPUTER-READABLE STORAGE MEDIUM FOR STORING POWER SUPPLY MANAGEMENT PROGRAM

(71) Applicant: FUJITSU LIMITED, Kawasaki-shi (JP)

(72) Inventors: Yu Yonezawa, Sagamihara (JP); YOSHIYASU NAKASHIMA, Kawasaki (JP)

(73) Assignee: FUJITSU LIMITED, Kawasaki-shi (JP)

(21) Appl. No.: 16/940,435

(22) Filed: Jul. 28, 2020

(30) Foreign Application Priority Data
Aug. 13, 2019 (JP) 2019-148500

(51) Int. Cl. H02M 3/158; H02M 3/157; H02M 1/08

(52) U.S. Cl. CPC H02M 3/1588; H02M 1/08; H02M 3/157

(57) ABSTRACT

A power supply device includes: a control circuit; a first switching element controlled by a first control signal having a duty ratio decided based on a difference between an output voltage of a power supply device and a target value, an integrated value of the difference, and a predetermined gain value; and a second switching element controlled by a second control signal having a phase opposite to a phase of the first control signal, the control circuit being configured to measure an input voltage of the power supply device, calculate a set duty ratio based on the input voltage and the target value, the set duty ratio being obtained by dividing a target duty ratio by the gain value, set the set duty ratio as an initial value of the integrated value, and control the first and second switching elements by generating the first and second control signals.

### CROSS-REFERENCE TO RELATED APPLICATION

This application is based upon and claims the benefit of priority of the prior Japanese Patent Application No. 2019-148500, filed on Aug. 13, 2019, the entire contents of which are incorporated herein by reference.

### FIELD

The embodiments discussed herein are related to a power supply device and a non-transitory computer-readable storage medium for storing a power supply management program.

### BACKGROUND

In a communication base station, an information processing device (such as a server), a processor module, or the like, a synchronous rectification type power supply device (switching power supply device) including two switching elements is used. Up to now, digital control of the synchronous rectification type power supply device has been performed using a control circuit such as a microcontroller. When the digital control is performed, advantages are attained that a timing of switching of each switching element may be precisely controlled, and also various functions may be implemented by software.

The control circuit that performs the digital control detects a difference between a measured value of an output voltage and a target value of the output voltage and performs feedback compensation for adjusting a duty ratio of a control signal (pulse signal) of each switching element such that the difference is decreased. The feedback compensation includes a technique for deciding the duty ratio based on a value obtained by adding the difference to an integrated value of the difference. When the integrated value is used, excessive adjustment to an abrupt fluctuation of the output voltage may be suppressed.

At the time of instantaneous power cut on an input side of the power supply device, for example, when the power supply device is reactivated, an adverse current may be generated by a voltage (referred to as pre-bias) based on charges remaining in a capacitor on a load side, and the switching element may be damaged in some cases. In this case, the power supply device may stop functioning to stop the system on the load side. Up to now, a power supply device has been proposed which has a function of avoiding, by maintaining one switching element in an off state into which an adverse current may flow at the time of activation out of the two switching element, the adverse current by a parasitic diode existing in the switching element.

Up to now, a switching power supply device has also been proposed which has an excess current protection circuit configured to avoid damage to a circuit element or the like from an excess current or an inrush current flowing onto a load side (examples of the related art include Japanese Laid-open Patent Publication. No. 2004-364488 and Japanese Laid-open Patent Publication No. 2016-226151).

### SUMMARY

According to an aspect of the embodiments, a power supply device includes: a synchronous rectification type switching power supply circuit; and a control circuit, wherein the switching circuit includes a first switching element configured to be controlled by a first control signal, the first control signal being a signal having a duty ratio decided based on a difference between an output voltage of a power supply device and a target value, an integrated value of the difference, and a predetermined gain value, and a second switching element configured to be controlled by a second control signal, the second control signal being a signal having a phase opposite to a phase of the first control signal, and wherein the control circuit is configured to measure an input voltage of the power supply device when the power supply device is activated, calculate a set duty ratio based on the input voltage and the target value, the set duty ratio being a value obtained by dividing a target duty ratio by the gain value, set the set duty ratio as an initial value of the integrated value to be reflected to the duty ratio, and generate the first control signal and the second control signal and control the first switching element and the second switching element.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates one example of a power supply device according to a first embodiment;

FIG. 2 illustrates one example of a power supply device that does not have a calculation function of a set duty ratio;

FIG. 3 illustrates an example of a control circuit of the power supply device that does not have the calculation function of the set duty ratio;

FIG. 4 is a timing chart illustrating an operation example of the power supply device that does not have the calculation function of the set duty ratio;

FIG. 5 illustrates one example of a power supply device according to a second embodiment;

FIG. 6 illustrates an example of a calculation expression of a set duty ratio in accordance with a circuit method of a switching power supply circuit;

FIG. 7 is a timing chart illustrating an operation example of the power supply device according to the second embodiment;

FIG. 8 illustrates a change example of an integrated value in the control circuit of the power supply device that does not have the calculation function of the set duty ratio;

FIG. 9 illustrates a change example of an integrated value in an MCU of the power supply device according to the second embodiment;

FIG. 10 is a drawing illustrating a reason why an output voltage does not become unstable even when the integrated value is increased at once;

FIG. 11 illustrates a comparison example of an advantage depending on the presence or absence of the calculation function of the set duty ratio based on a simulation;

FIG. 12 illustrates one example of a power supply device including a processor that calculates a duty ratio by executing a program; and

FIG. 13 is a flow chart illustrating a processing example performed when a power supply management program is executed.

### DESCRIPTION OF EMBODIMENT(S)

However, according to the related art technology for avoiding the adverse current by the pre-bias, an issue occurs that it takes long time until an output voltage reaches a target value at the time of activation.

According to an aspect of the present invention, it is aimed at providing a power supply device that may shorten the time until the output voltage reaches the target value at the time of activation and a power supply management program.

Embodiments of the present invention will be described below with reference to the drawings.

### First Embodiment

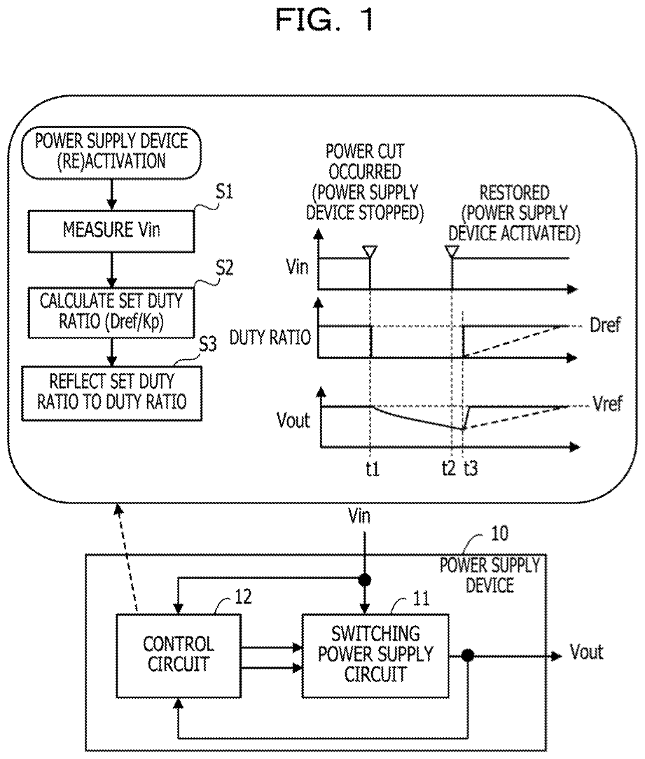

FIG. 1 illustrates one example of a power supply device according to a first embodiment.

A power supply device 10 according to the first embodiment includes a synchronous rectification type switching power supply circuit 11 and a control circuit 12.

The switching power supply circuit 11 includes a first switching element and a second switching element although not illustrated in FIG. 1. Hereinafter the first switching element is referred to as a main switch, and the second switching element is referred to as a synchronous rectification switch.

The main switch is controlled by a control signal having a duty ratio decided by a difference between an output voltage (Vout) of the power supply device 10 and a target value (Vref), an integrated value of the difference, and a predetermined gain value (Kp).

The synchronous rectification switch is controlled by a control signal having an opposite phase (phase is different by 180°) to a phase of the control signal for controlling the main switch. For this reason, the synchronous rectification switch turns off when the main switch is on, and turns on when the main switch is off.

A circuit method of the switching power supply circuit 11 includes a back method, a boost method, a back boost method, a fly back method, a forward method, and the like.

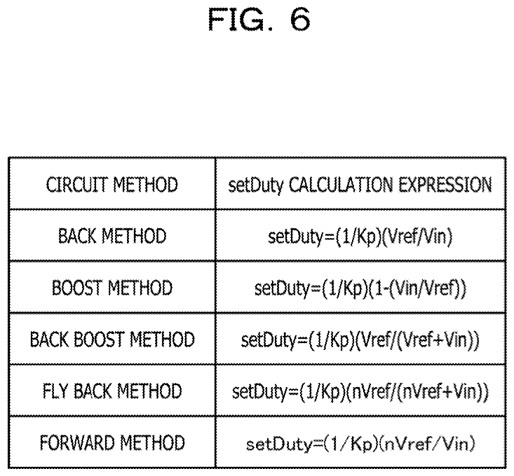

The control circuit 12 generates each aforementioned control signal and also has the following function. The control circuit 12 measures an input voltage (Vin) of the power supply device 10 at the time of activation of the power supply device 10 (also including the time of reactivation) (step S1). The control circuit 12 calculates a set duty ratio obtained by dividing a target duty ratio (Dref) at which Vref is obtained by Kp based on Vin and Vref (previously stored in a memory or the like, for example) (step S2). The set duty ratio is calculated based on a calculation expression in accordance with a circuit method of the switching power supply circuit 11 (see FIG. 6 described below). Thereafter, the control circuit 12 sets the set duty ratio as an initial value of the integrated value to be reflected to the duty ratio, and starts control of the main switch and the synchronous rectification switch (step S3).

### Advantages

Advantages of the power supply device 10 will be described below by comparing the power supply device 10 having the aforementioned calculation function of the set duty ratio according to the first embodiment with a power supply device that does not have the calculation function of the set duty ratio.

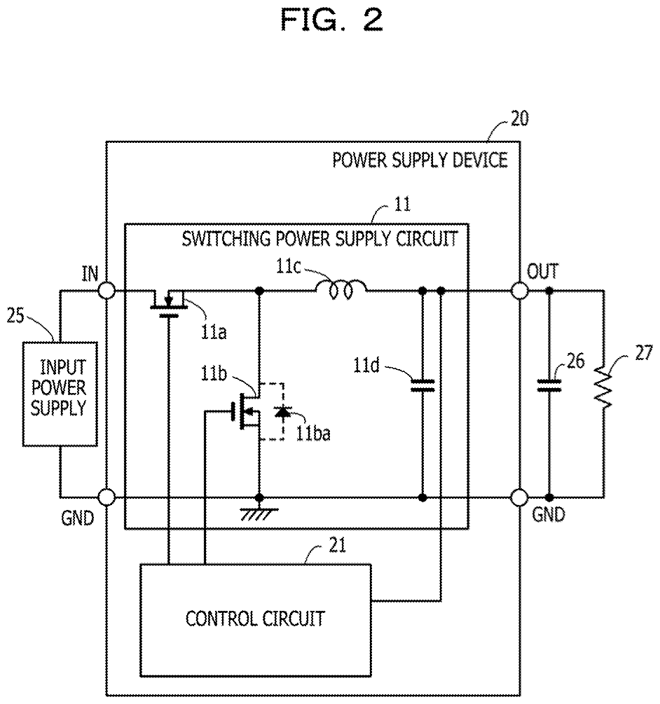

FIG. 2 illustrates one example of the power supply device that does not have the calculation function of the set duty ratio.

FIG. 2 illustrates a switching power supply circuit of the back method as one example of the switching power supply circuit 11, FIG. 2 illustrates an input power supply 25 coupled between an input terminal IN of a power supply device 20 and a ground terminal GND corresponding to a ground potential and configured to supply an input voltage to the power supply device 20, and a load capacitance 26 and a load resistance 27 coupled between an output terminal OUT of the power supply device 20 and the ground terminal GND.

The switching power supply circuit 11 includes n-channel type MOSFETs (hereinafter, abbreviated as nMOSs) 11a and 11b corresponding to one example of the switching element, an inductance element 11c, and a capacitance element 11d. One of drain/source terminals of the nMOS 11a is coupled to the input terminal IN, and the other one of the drain/source terminals of the nMOS 11a is coupled to one of drain/source terminals of the nMOS 11b and one terminal of the inductance element 11c. The other one of the drain/source terminals of the nMOS 11b is coupled to the ground terminal GND. The other terminal of the inductance element 11c is coupled to one terminal of the capacitance element 11d and the output terminal OUT. The other terminal of the capacitance element 11d is coupled to the ground terminal GND. FIG. 2 illustrates a parasitic diode 11ba generated by p-n junction in the nMOS 11b.

The nMOS 11a is equivalent to the main switch, and the nMOS 11b is equivalent to the synchronous rectification switch. Control signals having mutually opposite phases are supplied to gate terminals of the nMOSs 11a and 11b from the control circuit 21.

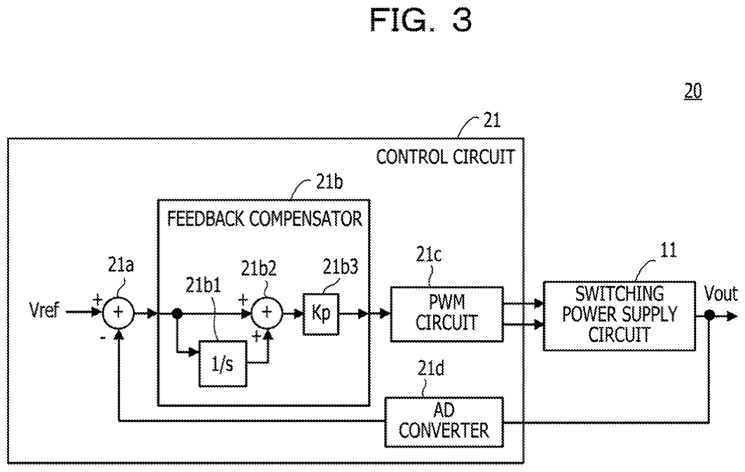

FIG. 3 illustrates an example of a control circuit of the power supply device that does not have the calculation function of the set duty ratio.

For example, the control circuit 21 is a micro control unit (MCU) and includes an adder 21a, a feedback compensator 21b, a pulse width modulation (PWM) circuit 21c, and an analog to digital (AD) converter 21d.

The adder 21a outputs a difference between the target value (Vref) (digital value) of the output voltage (Vout) of the switching power supply circuit 11 and a digital value of Vout.

The feedback compensator 21b includes an integrator 21b1, an adder 21b2, and a multiplier 21b3. The integrator 21b1 outputs an integrated value (integrated value of the difference) obtained by time-integrating the difference output by the adder 21a. The adder 21b2 outputs an addition result obtained by adding the difference output by the adder 21a to the integrated value output by the integrator 21b1.

The multiplier 21b3 calculates and outputs a value indicating a duty ratio (simply referred to as a duty ratio below) by multiplying the addition result output by the adder 21b2 by a predetermined gain value (Kp).

The PWM circuit 21c generates a control signal (pulse signal) having the duty ratio output by the multiplier 21b3 and supplies the control signal to the gate terminal of the nMOS 11a. The PWM circuit 21c further generates a control signal having a phase opposite to the phase of the control signal supplied to the gate terminal of the nMOS 11a and supplies the control signal to the gate terminal of the nMOS 11b. For example, when a logical level of the control signal supplied to the gate terminal of the nMOS 11a is H (High) level, a logical level of the control signal supplied to the gate terminal of the nMOS 11b is L (Low) level. When the logical level of the control signal supplied to the gate terminal of the nMOS 11a is L level, the logical level of the control signal supplied to the gate terminal of the nMOS 11b is H level. For this reason, when the nMOS 11a is in an on state, the nMOS 11b is in an off state, and when the nMOS 11a is in the off state, the nMOS 11b is in the on state.

The AD converter 21d converts Vout into a digital value.

In the aforementioned control circuit 21, functions of the adder 21a and the feedback compensator 21b may be realized, for example, when a central processing unit (CPU) and a memory corresponding to hardware are used, and the CPU executes a program. The adder 21a and the feedback compensator 21b may be realized by an electronic circuit for a specific purpose such as an application-specific integrated circuit (ASIC) or a field-programmable gate array (FPGA).

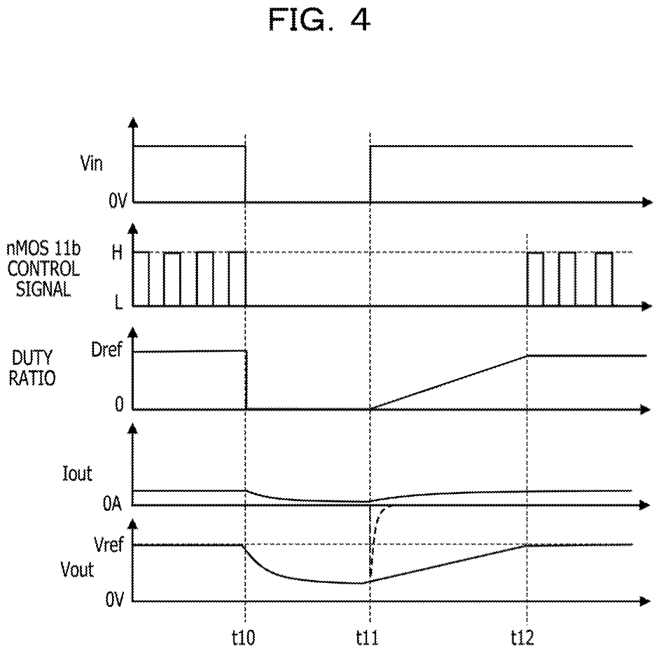

FIG. 4 is a timing chart illustrating an operation example of the power supply device that does not have the calculation function of the set duty ratio. FIG. 4 illustrates an example of temporal changes of the input voltage (Vin), the control signal supplied to the gate terminal of the nMOS 11b, the duty ratio output by the feedback compensator 21b, an output current (Iout), and Vout when instantaneous power cut occurs on the input side of the power supply device 20.

When power cut occurs and Vin becomes 0 V (timing t10), since the power supply to the control circuit 21 also stops, the control signal supplied to the gate terminal of the nMOS 11b becomes L level (control signal supplied to the gate terminal of the nMOS 11a also becomes L level although not illustrated). The duty ratio also becomes 0. When charges are accumulated in the capacitance element 11d or the load capacitance 26, Iout and Vout do not become 0 immediately, and are gradually decreased as illustrated in FIG. 4.

When the power cut is restored and Vin returns to the voltage before the power cut (timing t11), the control circuit 12 maintains the control signal supplied to the gate terminal of the nMOS 11b at L level, and maintains the nMOS 11b in the off state. This is because a situation is avoided where, when the nMOS 11b is immediately put into the on state at the time of reactivation of the power supply device 20 due to the restoration from the power cut, the adverse current is generated by the pre-bias based on the charges remaining in the load capacitance 26 (dotted line of Iout in FIG. 4) to cause damage to the nMOS 11b. When the nMOS 11b is maintained in the off state, the adverse current is avoided by the function of the parasitic diode 11ba.

When the nMOS 11b is maintained in the off state, a current mode of the switching power supply circuit 11 is put into a so-called discontinuous mode, and a gain is largely decreased (see Byungcho Choi, “Pulsewidth Modulated DC-to-DC Power Conversion”, United States, John Wiley & Sons, Inc., 2013, p. 424). When the gain is decreased, a degree at which the change of the duty ratio is reflected to Vout is decreased, and a rising speed of Vout is slowed.

In the power supply device 20, due to an influence from the integrator 21b1 of the feedback compensator 21b of the control circuit 21, it takes long time until the duty ratio reaches a value (value equivalent to Dref described above) at which the target value (Vref) of the output voltage is obtained. In the example of FIG. 4, at a timing t12, the duty ratio reaches Dref, and Vref is obtained. At and after the timing t12, the control signal supplied to the gate terminal of the nMOS 11b becomes the signal (pulse signal) having the opposite phase to the phase of the control signal having the duty ratio=Dref which is supplied to the gate terminal of the nMOS 11a.

It is conceivable to increase the gain value (Kp) to increase the rising speed of Vout, but the gain value is not increased to be equal to or higher than a certain level because vibration or oscillation is likely to occur in Vout (see Erickson, Robert Warren, “Fundamentals of Power Electronics Second Edition”, second edition, United States, Kluwer Academic Publishers, 2001, p. 346).

With respect to the power supply device 20 described above, in the power supply device 10 according to the First embodiment, the operations as illustrated in the timing chart of FIG. 1 are performed. For example, after the power cut occurs (timing t1), when the power cut is restored (the power supply device 10 is activated) (timing t2), the set duty ratio is reflected to the duty ratio immediately after the measurement of Vin and the calculation of the set duty ratio (timing t3).

For this reason, the timing when the duty ratio reaches Dref is earlier than the timing when the duty ratio with use of the power supply device 20 (indicated by a dotted line) reaches Dref. The time until Vout reaches Vref at the time of activation may also be shortened as compared with the time until Vout with use of the power supply device 20 (indicated by a dotted line) reaches Vref.

In the power supply device 10, since Vout is immediately increased after the activation, the adverse current to the synchronous rectification switch based on the pre-bias may also be suppressed.

### Second Embodiment

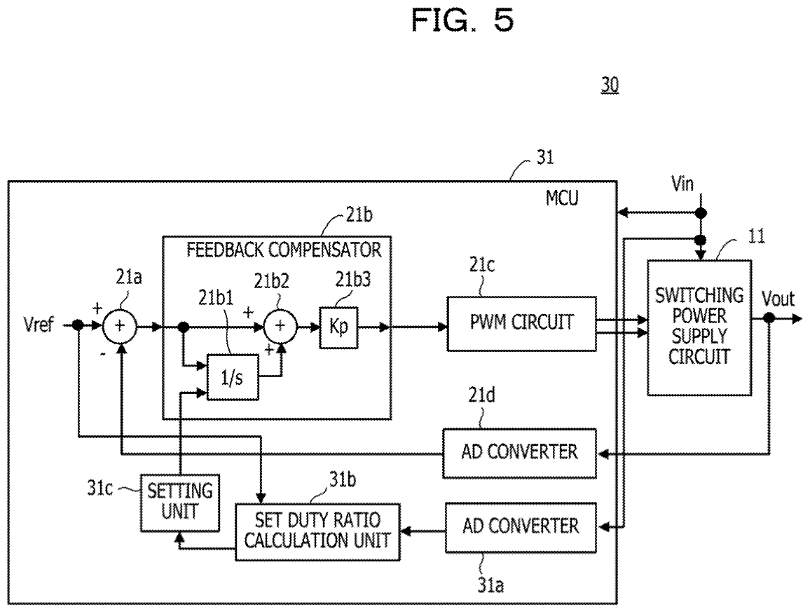

FIG. 5 illustrates one example of a power supply device according to a second embodiment. In FIG. 5, the same elements as the elements illustrated in FIGS. 1 to 3 are assigned with the same reference signs.

A power supply device 30 according to the second embodiment includes the switching power supply circuit 11 and an MCU 31.

The MCU 31 is one example of the control circuit 12 illustrated in FIG. 1, and includes an AD converter 31a, a set duty ratio calculation unit 31b, and a setting unit 31c in addition to the respective elements included in the control circuit 21 illustrated in FIG. 3.

The AD converter 31a has a function for measuring an input voltage (Vin) to the switching power supply circuit 11 and the MCU 31. The AD converter 31a converts Vin into a digital value and outputs the value as a measurement result.

The set duty ratio calculation unit 31b calculates a set duty ratio obtained by dividing Dref by Kp based on the digital value corresponding to the measurement result of Vin and Vref. When Vref is set to be variable, Vref may be stored in a rewritable memory such that the value may be changed, for example. The set duty ratio is calculated based on a different calculation expression in accordance with a circuit method of the switching power supply circuit 11.

FIG. 6 illustrates an example of the calculation expression of the set duty ratio in accordance with the circuit method of the switching power supply circuit. In FIG. 6, the set duty ratio is denoted by setDuty.

When the circuit method of the switching power supply circuit 11 is the back method, setDuty=(1/Kp)(Vref/Vin) is established, and when the circuit method is the boost method, setDuty=(1/K)(1−(Vin/Vref)) is established. When the circuit method is the back boost method, setDuty=(1/Kp)(Vref/(Vref+Vin)) is established, and when the circuit method is the fly back method, setDuty=(1/(Kp)(nVref/(nVref+Vin)) is established. A winding ratio of a transformer included in the switching power supply circuit 11 is denoted by n. When the circuit method is the forward method, setDuty=(1/Kp)(nVref/Vin) is established.

In this manner, the set duty ratio calculation unit 31b may calculate set duty ratios corresponding to various circuit methods.

For example, the set duty ratio calculation unit 31b may receive a signal indicating the circuit method of the switching power supply circuit 11 from the outside, and select the calculation expression of the set duty ratio to be used in accordance with the signal.

When the calculation of the set duty ratio is ended, the set duty ratio calculation unit 31b outputs a trigger signal indicating that the calculation is ended together with the calculation result.

When the aforementioned trigger signal is received, the setting unit 31c sets the calculated set duty ratio as an initial value of the integrated value in the integrator 21b1 of the feedback compensator 21b.

The functions of the set duty ratio calculation unit 31b and the setting unit 31c may also be realized when the CPU executes the program using the CPU and the memory similarly as in the functions of the adder 21a and the feedback compensator 21b, for example. The set duty ratio calculation unit 31b and the setting unit 31c may also be realized by an electronic circuit for a specific purpose such as an ASIC or an FPGA. For example, the setting unit 31c may also be realized using a switch circuit or the like.

The feedback compensator 21b is not limited to the configuration illustrated in FIG. 5.

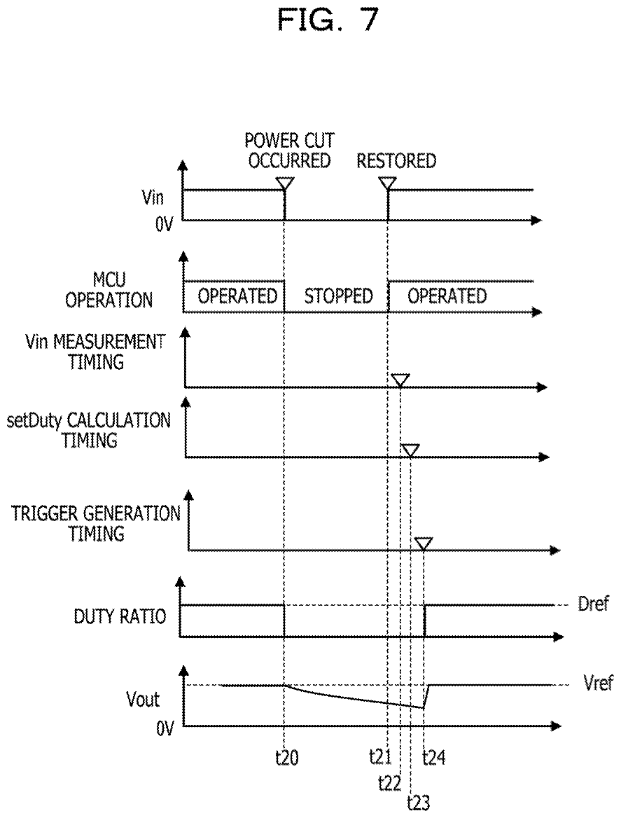

FIG. 7 is a timing chart illustrating an operation example of the power supply device according to the second embodiment. FIG. 7 illustrates examples of the temporal change of Yin, the operation of the MCU 31, the Vin measurement timing, the setDuty calculation timing, the trigger generation timing, the temporal change of the duty ratio, and the temporal change of Vout.

When the power cut occurs and Vin becomes 0 V (timing t20), the operation of the MCU 31 is stopped, and the duty ratio also becomes 0. Vout does not become 0 immediately due to the aforementioned region and is gradually decreased.

When the power cut is restored (timing t21) and the MCU 31 resumes the operation, the AD converter 31a of the MCU 31 converts Vin into a digital value and outputs the digital value as the measurement result (timing t22). Thereafter, the set duty ratio calculation unit 31b calculates the set duty ratio (setDuty) represented by a different expression based on the circuit method of the switching power supply circuit 11 (timing t23). When the calculation of the set duty ratio is ended, the set duty ratio calculation unit 31b outputs the trigger signal (timing t24). Thus, the set duty ratio is set in the integrator 21b1 of the feedback compensator 21b as the initial value of the integrated value, and the duty ratio corresponding to the output of the feedback compensator 21b becomes Dref. The PWM circuit 21c supplies the control signal in which Dref is set as the duty ratio to the main switch of the switching power supply circuit 11, and supplies the control signal having the opposite phase to the phase of the control signal supplied to the main switch, to the synchronous rectification switch. Thus, Vout increases and reaches Vref.

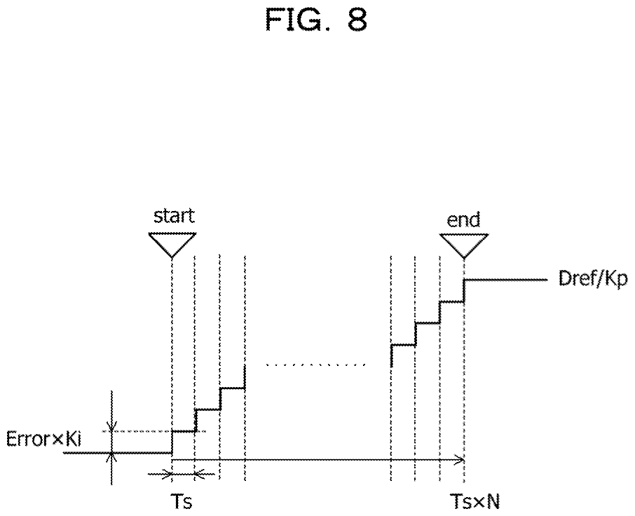

FIG. 8 illustrates a change example of an integrated value in the control circuit of the power supply device that does not have the calculation function of the set duty ratio.

In the control circuit 21 of the power supply device 20 that does not have the calculation function of the set duty ratio illustrated in FIG. 3, a value obtained by multiplying the error signal (Error) corresponding to the difference output by the adder 21a by an integration gain (Ki) is integrated in each sampling cycle (Ts) of the AD converter 21d. In the example of FIG. 8, after Ts×N elapses since the integration is started, the integrated value reaches Dref/Kp. N is a value of approximately several hundreds to several thousands.

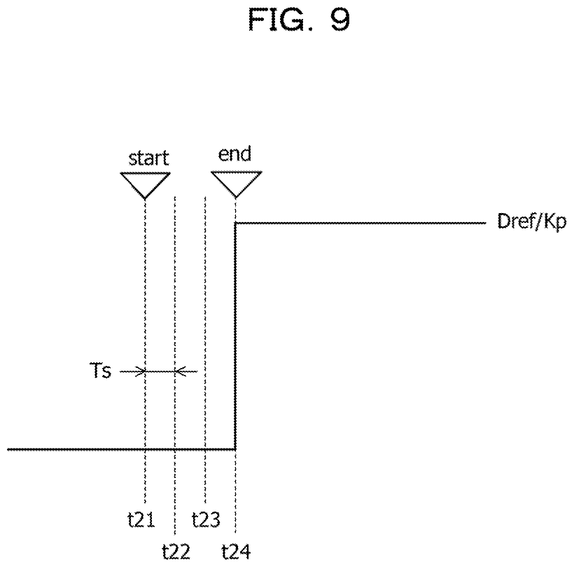

FIG. 9 illustrates a change example of an integrated value in an MCU of the power supply device according to the second embodiment

As illustrated in FIG. 7, when the MCU 31 starts the operation at the timing t21, the measurement result of Vin is obtained at the timing t22 after the sampling cycle (Ts) of the AD converter 31a. The calculation of the set duty ratio (Dref/Kp) is performed at the timing t23 after the next Ts, and the calculated set duty ratio is set as the initial value of the integrated value in the integrator 21b1 at the timing t24 after the Ts after next.

In this manner, in the example of FIG. 9, the integrated value reaches Dref/Kp after the time equivalent to Ts×3 elapses since the MCU 31 starts the operation.

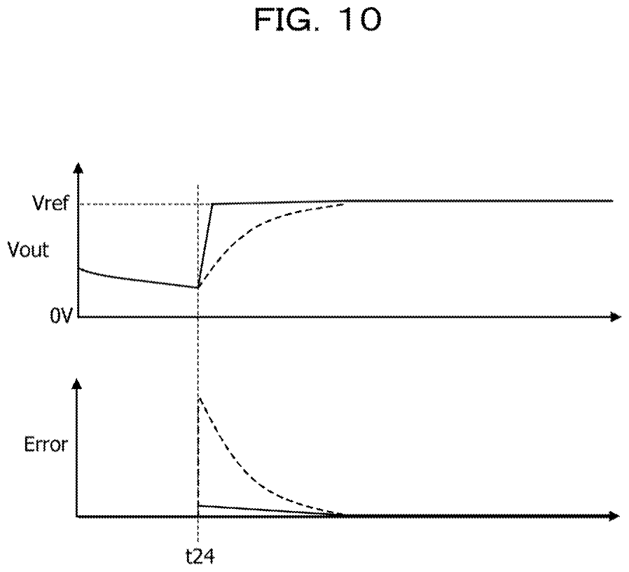

FIG. 10 is a drawing illustrating a reason why an output voltage does not become unstable even when the integrated value is increased at once. FIG. 10 illustrates an example of temporal changes of Vout and the error signal (Error). For comparison, in FIG. 10, the example of Vout and Error in the power supply device 20 that does not have the calculation function of the set duty ratio as illustrated in FIG. 3 is indicated by a dotted line.

In accordance with the power supply device 30 according to the second embodiment, Vref and Vout become values close to each other immediately after the reactivation. When Vref and Vout are close values, since a value of the error signal (Error) (input value of the feedback compensator 21b) becomes low, a large fluctuation does not occur in the output of the feedback compensator 21b. In accordance with the power supply device 30, since the initial value of the duty ratio is increased by setting the initial value of the integrated value as the set duty ratio without increasing the gain value (Kp), Vout does not become unstable even after the duty ratio is increased, and the vibration or the like does not occur.

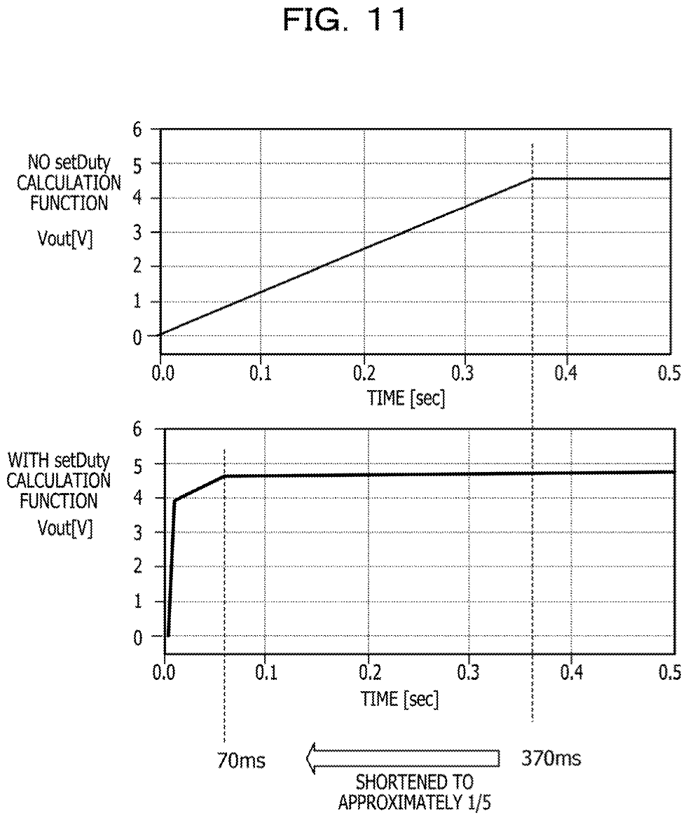

FIG. 11 illustrates a comparison example of an advantage depending on the presence or absence of the calculation function of the set duty ratio based on a simulation. The vertical axis represents Vout [V], and the horizontal axis represents time [sec].

FIG. 11 illustrates an example of simulation results of the temporal changes of Vout in the power supply device 20 that does not have the calculation function of the set duty ratio (setDuty) as illustrated in FIG. 3 and the power supply device 30 having the calculation function of the set duty ratio according to the second embodiment. The power supply devices 20 and 30 are configured to decrease Vin=12 V to Vout=5 V. For this reason, the back method is used as the circuit method of the switching power supply circuit 11. The pre-bias is set as 0 V.

As illustrated in FIG. 11, it takes 370 ms until Vout reaches 5 V in the power supply device 20 that does not have the calculation function of the set duty ratio, and it takes 70 ms until Vout reaches 5 V in the power supply device 30. For this reason, the power supply device 30 shortens the time until Vout rises from 0 V and reaches 5 V corresponding to the target value to approximately ⅕ as compared with the power supply device 20.

In the MCU 31 as described above, the elements configured to calculate the duty ratio (the adder 21a, the feedback compensator 21b, the set duty ratio calculation unit 31b, and the setting unit 31c) may be realized when a processor such as a CPU executes the program.

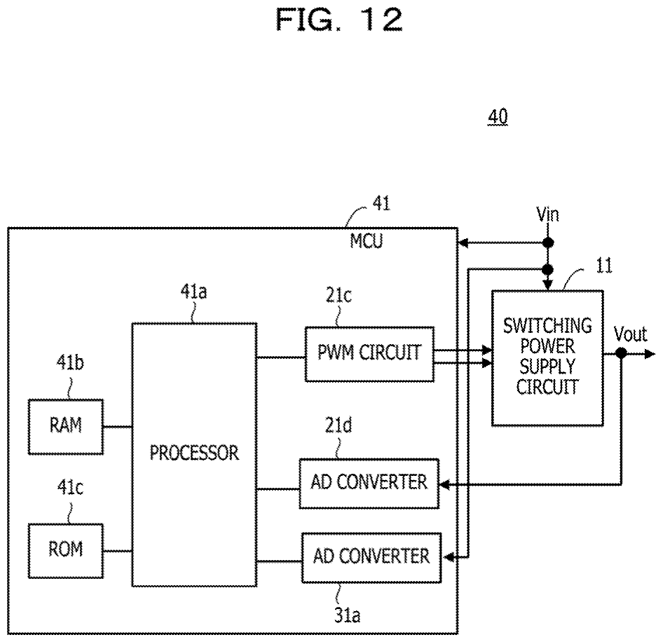

FIG. 12 illustrates one example of the power supply device including the processor that calculates the duty ratio by executing the program. In FIG. 12, the same elements as the elements illustrated in FIG. 5 are assigned with the same reference signs.

An MCU 41 of a power supply device 40 includes a processor 41a, a random-access memory (RAM) 41b, and a read-only memory (ROM) 41c.

The processor 41a includes an arithmetic circuit that executes program instructions. The processor 41a includes a CPU, a digital signal processor (DSP), or the like. The processor 41a loads at least a part of a program and data stored in the ROM 41c into the RAM 41b and executes the program. The processor 41a may also include multiple processors or multiple processor cores.

The RAM 41b is a volatile semiconductor memory that temporarily stores a program executed by the processor 41a and data used for computation by the processor 41a.

The ROM 41c stores data such as, for example, an operating system (OS), a program (power supply management program) for controlling the calculation of the duty ratio and each unit of the MCU 41, and the calculation expressions of the set duty ratio in accordance with the circuit methods of the switching power supply circuit 11.

The MCU 41 may include other pes of storage devices such as a flash memory and a solid state drive (SSD).

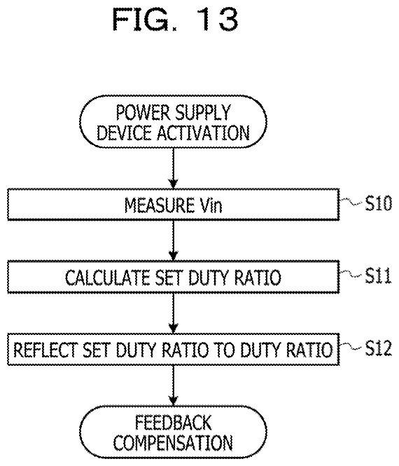

FIG. 13 is a flow chart illustrating a processing example performed when the power supply management program is executed.

When the power supply device 40 is activated, the processor 41a measures Vin by causing the AD converter 31a to convert Vin into a digital value (step S10).

Thereafter, the processor 41a calculates the set duty ratio similarly as in the aforementioned set duty ratio calculation unit 31b (step S11).

The processor 41a sets the calculated set duty ratio as the initial value of the integrated value to be reflected to the duty ratio (step S12).

Thereafter, the processor 41a performs the feedback compensation. The feedback compensation by the processor 41a is performed as follows, for example. The processor 41a and the AD converter 21d are caused to convert Vout into a digital value, and based on a difference between the converted digital value of Vout and Vref, the duty ratio is decided by similar processing to the processing by the aforementioned feedback compensator 21b. The processor 41a causes the PWM circuit 21c to generate a control signal having the duty ratio and also generate a control signal having the opposite phase to the phase of the aforementioned control signal. The main switch and the synchronous rectification switch of the switching power supply circuit 11 are operated by these control signals.

When such a power supply management program is executed, the advantage similar to the aforementioned advantage may be obtained that the time until Vout reaches Vref may be shortened at the time of activation of the power supply device 40.

The power supply management program may be recorded on a computer-readable recording medium (such as a recording medium). As the recording medium, for example, a magnetic disk, an optical disk, a magneto-optical disk, a semiconductor memory, and the like may be used. The magnetic disk includes a flexible disk (FD) and a hard disk drive (HDD). The optical disk includes a compact disc (CD), a CD-recordable (R)/rewritable (RW), a digital versatile disc (DVD), and a DVD-R/RW. The program may be recorded and distributed on a portable recording medium. In this case, the program may be copied from the portable recording medium to another recording medium and executed.

Although aspects of the power supply device and the power supply management program of the present invention have been described thus far based on the embodiments, these are merely examples and are not limited to the above description.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention

What is claimed is:

1. A power supply device comprising:
a synchronous rectification type switching power supply circuit; and
a control circuit,
wherein the switching circuit includes
a first switching element configured to be controlled by a first control signal, the first control signal being a signal having a duty ratio decided based on a difference between an output voltage of a power supply device and a target value, an integrated value of the difference, and a predetermined gain value, and
a second switching element configured to be controlled by a second control signal, the second control signal being a signal having a phase opposite to a phase of the first control signal, and
wherein the control circuit is configured to
measure an input voltage of the power supply device when the power supply device is activated,
calculate a set duty ratio based on the input voltage and the target value, the set duty ratio being a value obtained by dividing a target duty ratio by the gain value,
set the set duty ratio as an initial value of the integrated value to be reflected to the duty ratio, and
generate the first control signal and the second control signal and control the first switching element and the second switching element.

2. The power supply device according to claim 1,
wherein the control circuit is configured to calculate the set duty ratio based on a calculation expression in accordance with a circuit method of the switching power supply circuit.

3. The power supply device according to claim 1,
wherein the control circuit includes an AD converter configured to convert the input voltage and the output voltage into digital values, and
wherein the control circuit is configured to
convert the input voltage into the digital value after a sampling cycle of the AD converter since the power supply device is activated,
calculate the set duty ratio after the next sampling cycle, and
reflect the set duty ratio to the duty ratio after the sampling cycle after next.

4. The power supply device according to claim 1,
wherein the control circuit includes
a first adder configured to calculate the difference,
an integrator configured to output the integrated value,
a second adder configured to output an addition result of the difference and the integrated value,
a multiplier configured to multiply the addition result by the gain value to output a value indicating the duty ratio,
a set duty ratio calculation circuit configured to calculate the set duty ratio, and
a setting circuit configured to set the set duty ratio as the initial value in the integrator when the power supply device is activated.

5. A non-transitory computer-readable storage medium for storing a power supply management program which causes a processor to perform processing, the processor being included in a power supply device, the power supply device including the processor, a first switching element, and a second switching element, the first switching element being configured to being controlled by a first control signal, the first control signal being a signal having a duty ratio decided based on a difference between an output voltage of the power supply device and a target value, an integrated value of the difference, and a predetermined gain value, the second switching element being configured to being controlled by a second control signal, and the second control signal being a signal having a phase opposite to a phase of the first control signal, the processing comprising:
measuring an input voltage of the power supply device when the power supply device is activated;
calculating a set duty ratio based on the input voltage and the target value, the set duty ratio being a value obtained by dividing a target duty ratio by the gain value;
set the set duty ratio as an initial value of the integrated value to be reflected to the duty ratio, and
generating the first control signal and the second control signal and controlling the first switching element and the second switching element.

6. The non-transitory computer-readable storage medium according to claim 5,
the processing further comprising:
calculating the set duty ratio based on a calculation expression in accordance with a circuit method of the switching power supply circuit.

7. The non transitory computer-readable storage medium according to claim 5,
wherein the power supply device includes an AD converter configured to convert the input voltage and the output voltage into digital values, and
wherein the processing further includes:
converting the input voltage into the digital value after a sampling cycle of the AD converter since the power supply device is activated,
calculating the set duty ratio after the next sampling cycle, and
reflecting the set duty ratio to the duty ratio after the sampling cycle after next.

8. The non-transitory compute readable storage medium according to claim 5,
wherein the power supply device further includes
a first adder configured to calculate the difference,
an integrator configured to output the integrated value,
a second adder configured to output an addition result of the difference and the integrated value,
a multiplier configured to multiply the addition result by the gain value to output a value indicating the duty ratio,
a set duty ratio calculation circuit configured to calculate the set duty ratio, and
a setting circuit configured to set the set duty ratio as the initial value in the integrator when the power supply device is activated.
